(19) United States
(12) Patent Application Publication
(10) Pub. No.: US 2023/0394821 A1
(43) Pub. Date: Dec. 7, 2023

(54) AUTOMATICALLY LABELING METHOD OF TRAINING DATA AND ELECTRONIC DEVICE THEREOF

(71) Applicant: IRONYUN INC., Zhubei City (TW)

(72) Inventor: Chia-Ming CHANG, Zhubei City (TW)

(21) Appl. No.: 17/833,975

(22) Filed: Jun. 7, 2022

(51) Int. Cl. G06V 20/40; G06K 9/62

(52) U.S. Cl. CPC G06V 20/41; G06K 9/6259; G06F 3/0481

(57) ABSTRACT

An automatically labeling method of training data is executed by an automatically labeling electronic device including a processor, a camera, and a screen. The processor uses the camera to record a training video by aiming a mark displayed on a marking position of the screen. After the training video is completed, the processor further respectively generates a target scope according to the marking position for each of the frames, and respectively labels an object in the target scope of each of the frames of the training video as training data. Therefore, the processor can automatically label the object by the target scopes of the objects in the frames of the training video as the training data of a model for saving a lot of manpower and time.

### BACKGROUND OF THE INVENTION

### 1. Field of the Invention

The present invention relates to a labeling method and an electronic device thereof, especially an automatically labeling method of training data, and an electronic device thereof.

### 2. Description of the Related Art

Artificial intelligence (AI) is a category of computer science, which means that machines have the same thinking logic and behavior patterns as humans.

Further, machine learning is one of the ways to achieve the AI. The machine learning builds a model based on training data in order to allow the machines to learn from the training data, so that the machines can make predictions or decisions by the model.

One of the applications of using the model of the machine learning is image recognition. However, when preparing the training data of the model, it is usually necessary to manually label objects in images, which takes a lot of manpower and time. Therefore, a method for manually labeling the objects in the images needs to be improved.

### SUMMARY OF THE INVENTION

In view of the above-mentioned needs, the main purpose of the present invention is to provide an automatically labeling method of training data, and an electronic device thereof. The automatically labeling electronic device of training data includes a camera, a screen, and a processor. The processor is electrically connected to the camera and the screen.

The processor executes the automatically labeling method of training data to start the camera, display a mark on a marking position of the screen, and determine whether a record button is triggered.

When the record button is triggered, the processor starts recording a training video, and determines whether a stop button is triggered.

When the stop button is triggered, the processor stops recording the training video to complete the training video, and the training video includes a plurality of frames and the marking position.

Further, after the training video is completed, the processor respectively generates a target scope according to the marking position for each of the frames, and respectively labels an object in the target scope of each of the frames of the training video as training data.

Therefore, the automatically labeling electronic device of the present invention can automatically prepare the training data, so that manpower and time can be reduced.

Therefore, the automatically labeling electronic device of the present invention can automatically label the objects in the frame of the training video as the training data. Namely, the present invention can allow a user to automatically label the objects in the frames of the training video when the training video is recorded for saving a lot of manpower and time.

### BRIEF DESCRIPTION OF THE DRAWINGS

FIGS. 1A and 1B are flowcharts of an automatically labeling method of training data of the present invention;

FIG. 2 is a block diagram of an automatically labeling electronic device of training data of the present invention;

FIG. 3 is a schematic diagram of an image displayed by a screen of the automatically labeling electronic device when displaying a mark on a marking position of the screen;

FIGS. 4A to 4F are schematic diagrams of images displayed by the screen of the automatically labeling electronic device when recording a training video;

FIG. 5 is a schematic diagram of an image displayed by the screen of the automatically labeling electronic device when stopping recording the training video;

FIGS. 6A to 6D are schematic diagrams of images displayed by the screen of the automatically labeling electronic device for displaying different embodiments of the mark;

FIGS. 7A to 7C are schematic diagrams for showing steps of generating a target scope of each of the frames of the training video.

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of, not all of, the embodiments of the present invention. Based on the embodiments of the present invention, all other embodiments obtained by a person of ordinary skill in the art without creative efforts shall fall within the protection scope of the present invention.

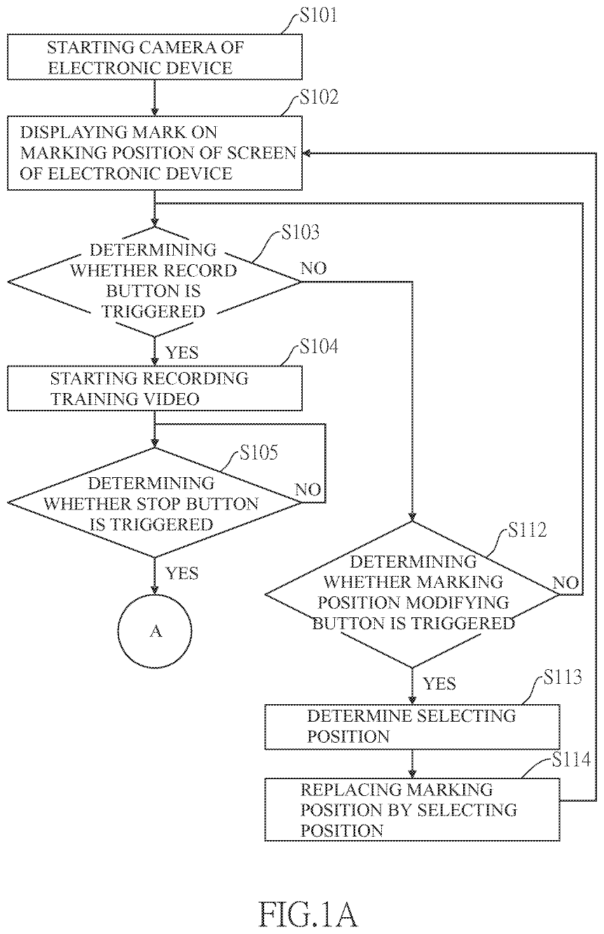

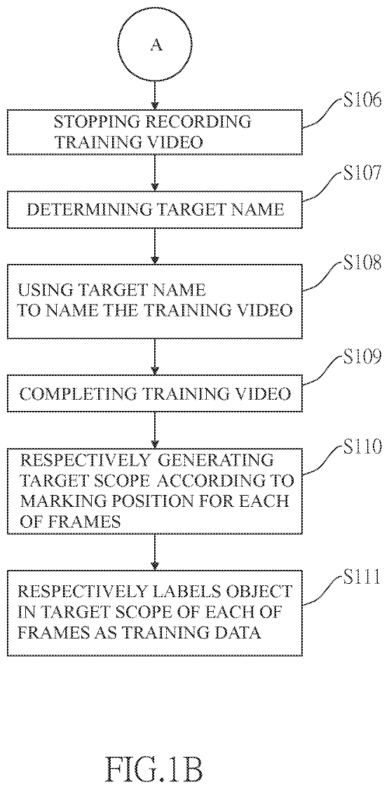

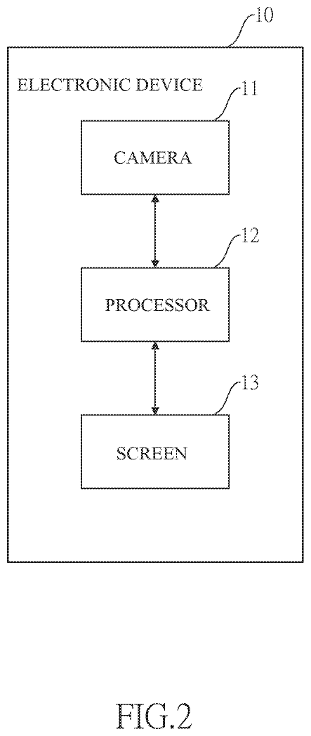

FIGS. 1A and 1B are flowcharts of an automatically labeling method of training data, which is executed by an automatically labeling electronic device of training data. Further with reference to FIG. 2, FIG. 2 is a block diagram of the automatically labeling electronic device 10. The automatically labeling electronic device 10 includes a camera 11, a processor 12, and a screen 13. The processor 12 is electrically connected to the camera 11 and the screen 13. In an embodiment, the automatically labeling electronic device 10 may be a smart phone, a tablet, a digital camera, or any electronic device having a camera and a screen.

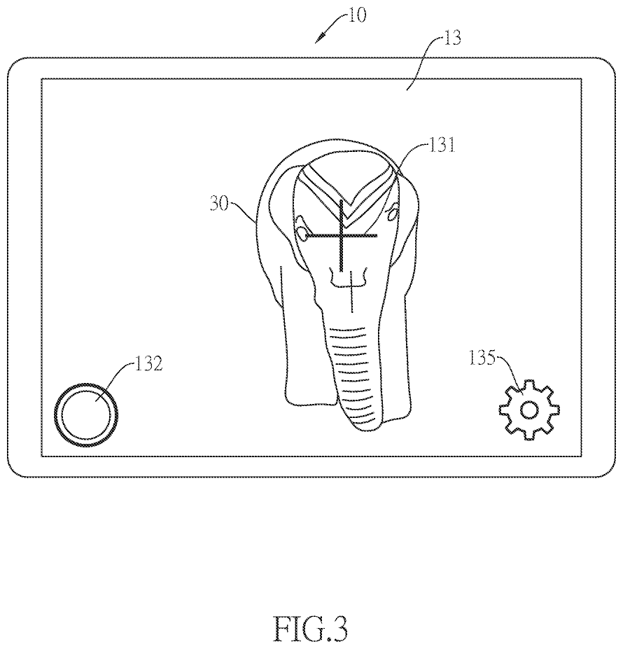

In steps S101 to S103, when the processor 12 executes the automatically labeling method of training data, the processor 12 starts the camera 11, displays a mark 131 on a marking position of the screen 13, and determines whether a record button 132 is triggered. For example, with reference to FIG. 3, the marking position is a center of the screen 13, the mark 131 is a cross, and the record button 132 is displayed at a bottom left corner of the screen 13. The camera 11 is used to capture an object 30 for training a model to recognize the object 30. For example, the object 30 is an elephant, and a user can use the camera 11 of the automatically labeling electronic device 10 to capture the object 30. Since the object 30 should be aimed at the marking position, the user can use the mark 131 to aim the object 30 at the marking position. In the embodiment, the mark 131 is only displayed when the training video is recording. When the training video is completed, the mark 131 would not be displayed in the completed training video. Namely, the completed training video is recorded only when accompanied with the marking position and without the mark 131.

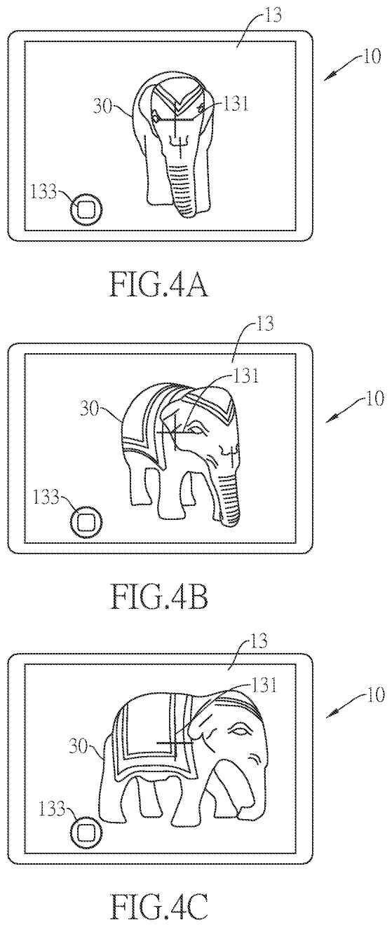

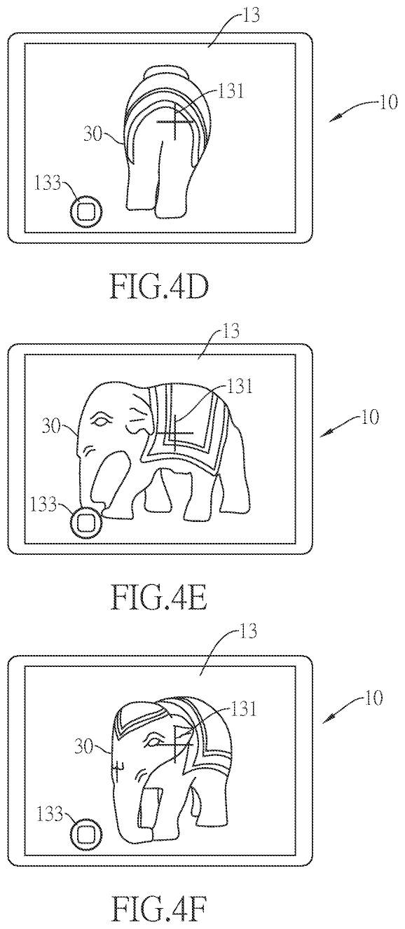

In steps S104 to S105, when the record button 132 is triggered, the processor 12 starts recording a training video, and determines whether a stop button 133 is triggered. For example, with reference to FIG. 4A, when the record button 132 is triggered, the screen 13 displays the stop button 133 at the bottom left corner of the screen 13, and the user can use the automatically labeling electronic device 10 to record the training video. With reference to FIGS. 4A to 4F, when the user uses the automatically labeling electronic device 10 to record the training video, the user aims the object 30 at the marking position of the screen 13 by using the mark 131, and the user holds the automatically labeling electronic device 10 to move around the object 30 for recording a surrounding view of the object 30. Since the training video includes a plurality of frames, and the frames have captured the object 30, each of the frames can be used as one training datum for training the model. Therefore, the training video including the plurality of frames can be used to train the model for recognizing the object 30.

In steps S106 to S109, when the stop button 133 is triggered, the processor 12 stops recording the training video, determines a target name, uses the target name to name the training video, and then completes the training video. For example, with reference to FIG. 5, when the stop button 133 is triggered, the screen 13 displays a name input field 134. Therefore, the processor 12 can determine the target name by the user inputting the target name into the name input field 134. Then, the processor 12 can name the training video by the target name to complete the training video.

In steps S110 to S111, after the training video is completed, the processor 12 further respectively generates a target scope according to the marking position for each of the frames of the training video, and respectively labels the object 30 in the target scope of each of the frames of the training video as training data for training the model. In the embodiment, the processor 12 labels the objects 30 by the target name determined in step S107.

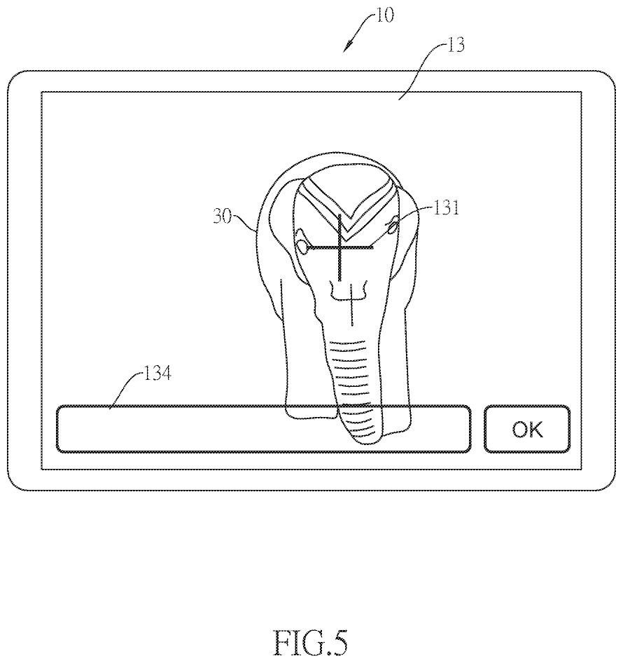

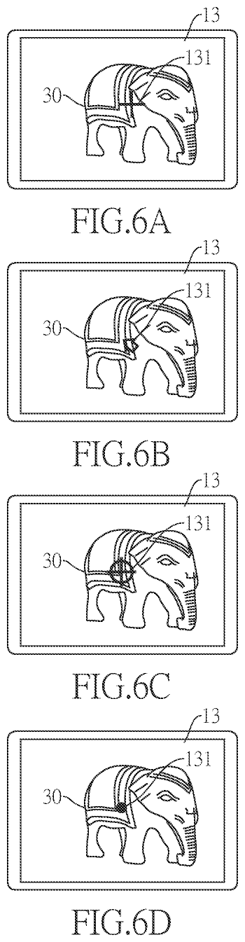

Moreover, with reference to FIG. 6A, in the embodiment, the mark 131 displayed on the marking position of the screen 13 of the automatically labeling electronic device 10 is a cross. With reference to FIGS. 6B to 6C, in other embodiments, the mark 131 may be an arrow, an aim, or a dot.

In steps S112 to S114, when the record button 132 is untriggered, the processor 12 further determines whether a marking position modifying button 135 is triggered. For example, with reference to FIG. 3, the marking position modifying button 135 is displayed at a bottom right corner of the screen 13. When the marking position modifying button 135 is triggered, the processor 12 determines a selecting position, replaces the marking position by the selecting position, and displays the mark 131 on the marking position of the screen again. Namely, the user can modify the marking position by using the marking position modifying button 135. For example, the user can select a top right corner of the screen 13 to be the marking position.

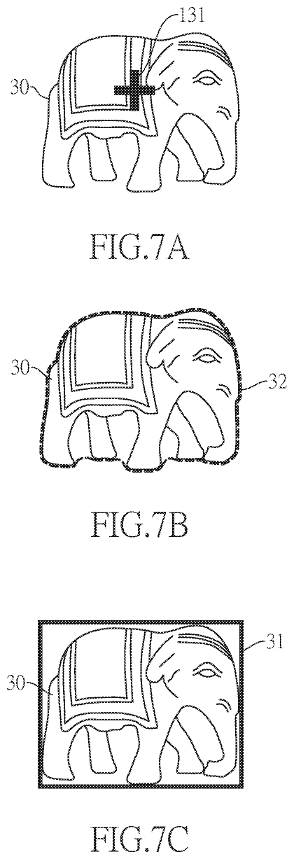

Moreover, with reference to FIGS. 7A to 7C, when the processor 12 generates the target scope of each of the frames of the training video, the processor 12 further determines a contour 32 of the object 30 according to the marking position displaying the mark 131, and generates the target scope 31 according to the contour 32 of the object 30. Since the user aims the mark 131 at the object 30 when the user records the training video, the object 30 is displayed at least at the marking position displaying the mark 131. For example, the contour 32 of the object 30 is determined by the Open Source Computer Vision Library (OpenCV).

In the embodiment, each of the target scopes of the frames is a circumscribed polygon of the contour of the object, and the circumscribed polygon is a rectangle. For example, the processor 12 determines a maximum and a minimum in X axis, and a maximum and a minimum in Y axis, to be four endpoints of the rectangle. Namely, the four endpoints of the rectangle are (Xₘₐₓ, Yₘₐₓ), (Xₘₐₓ, Yₘᵢₙ), (Xₘᵢₙ, Yₘᵢₙ), and (Xₘᵢₙ, Yₘₐₓ). The Xₘₐₓ is the maximum in the X axis, Xₘᵢₙ is the minimum in the X axis, Yₘₐₓ is the maximum in the Y axis, and Yₘᵢₙ is the minimum in the Y axis.

In conclusion, the processor 12 can automatically determine the target scope of the object 30 according to the marking position displaying the mark 131. Further, the processor 12 can automatically label the object 30 by the target name. Therefore, the automatically labeling electronic device 10 can use the target name and the target scope to automatically label the objects 30 in the frames of the training video as the training data of the model for saving a lot of manpower and time.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An automatically labeling method of training data, executed by a processor of an electronic device, and comprising steps of:
starting a camera of the electronic device;
displaying a mark on a marking position of a screen of the electronic device;
determining whether a record button is triggered;
when the record button is triggered, starting recording a training video, and determining whether a stop button is triggered;
when the stop button is triggered, stopping recording the training video to complete the training video; wherein the training video comprises a plurality of frames and the marking position;
after the training video is completed, respectively generating a target scope according to the marking position for each of the frames, and respectively labeling an object in the target scope of each of the frames of the training video as training data.

2. The automatically labeling method of the training data as claimed in claim 1, further comprising steps of:
when the record button is untriggered, determining whether a marking position modifying button is triggered;
when the marking position modifying button is triggered, determining a selecting position, replacing the marking position by the selecting position, and displaying the mark on the marking position of the screen of the electronic device again.

3. The automatically labeling method of the training data as claimed in claim 1, wherein the step of stopping recording the training video to complete the training video further comprises sub-steps of:
stopping recording the training video;
determining a target name;
using the target name to name the training video; and
completing the training video.

4. The automatically labeling method of the training data as claimed in claim 3, wherein when the objects in the target scopes of the frames of the training video are labeled, the objects are labeled by the target name.

5. The automatically labeling method of the training data as claimed in claim 1, wherein the mark displayed on the marking position of the screen of the electronic device is a cross, an arrow, an aim, or a dot.

6. The automatically labeling method of the training data as claimed in claim 1, wherein the target scope of each of the frames is generated by sub-steps of:
determining a contour of the object according to the marking position; wherein the object is displayed at least at the marking position; and
generating the target scope according to the contour of the object.

7. The automatically labeling method of the training data as claimed in claim 1, wherein each of the target scopes of the frames is a circumscribed polygon of the contour of the object.

8. The automatically labeling method of the training data as claimed in claim 7, wherein the circumscribed polygon is a rectangle.

9. An automatically labeling electronic device of training data, comprising:
a camera;
a screen; and
a processor, electrically connected to the camera and the screen;
wherein the processor starts the camera, and displays a mark on a marking position of the screen;
wherein the processor further determines whether a record button is triggered;
wherein when the record button is triggered, the processor starts recording a training video, and determines whether a stop button is triggered;
wherein when the stop button is triggered, the processor stops recording the training video to complete the training video;
wherein the training video comprises a plurality of frames and the marking position;
wherein after the training video is completed, the processor respectively generates a target scope according to the marking position for each of the frames, and respectively labels an object in the target scope of each of the frames of the training video as training data.

10. The automatically labeling electronic device of the training data as claimed in claim 9, wherein when the record button is untriggered, the processor determines whether a marking position modifying button is triggered; and
wherein when the marking position modifying button is triggered, the processor determines a selecting position, replaces the marking position by the selecting position, and displays the mark on the marking position of the screen again.

11. The automatically labeling electronic device of the training data as claimed in claim 9, wherein when the processor stops recording the training video to complete the training video, the processor further stops recording the training video, determines a target name, uses the target name to name the training video, and then completes the training video.

12. The automatically labeling electronic device of the training data as claimed in claim 11, wherein when the processor labels the objects in the target scopes of the frames of the training video, the processor labels the objects by the target name.

13. The automatically labeling electronic device of the training data as claimed in claim 9, wherein the mark displayed on the marking position of the screen of the automatically labeling electronic device is a cross, an arrow, an aim, or a dot.

14. The automatically labeling electronic device of the training data as claimed in claim 9, wherein when the processor generates the target scope of each of the frames, the processor further determines a contour of the object according to the marking position, and generates the target scope according to the contour of the object; and
wherein the object is displayed at least at the marking position.

15. The automatically labeling electronic device of the training data as claimed in claim 9, wherein each of the target scopes of the frames is a circumscribed polygon of the contour of the object.

16. The automatically labeling electronic device of the training data as claimed in claim 15, wherein the circumscribed polygon is a rectangle.
